(19) United States
(12) Patent Application Publication
(10) Pub. No.: US 2007/0096045 A1
(43) Pub. Date: May 3, 2007

(54) Solid state radiation detector

(75) Inventors: Ryouzou Kaito, Kanagawa-ken (JP); Shigeru Nakamura, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/590,774

(22) Filed: Nov. 1, 2006

(30) Foreign Application Priority Data
Nov. 1, 2005 (JP) 318257/2005

(51) Int. Cl. G01N 23/04

(52) U.S. Cl. 250/582

(57) ABSTRACT

For a solid state radiation detector of multi-layered body including a photoconductive layer, the photoconductive layer is sealed by a polymer film formed by chemical vapor deposition as the sealing method that does not develop any gap in the sealing section and requires no adhesive, in order to prevent the problems of spotty image, discharge breakdown, and the like caused by a gap developed in the sealing section or adhesive when sealing the photoconductive layer from the air.

### BACKGROUND OF THE INVENTION

1. Field of the Invention

The present invention relates to a solid state radiation detector that includes a photoconductive layer formed mainly of amorphous selenium. More specifically, the present invention relates to the protection of the photoconductive layer.

2. Description of the Related Art

Today, in X-ray (radiation) imaging for medical diagnosis and the like, various types of X-ray image recording/readout systems are proposed and put into practical use. Such system uses a solid state radiation detector (detector that employs semiconductors in the main section) as the X-ray image information recording means, and X-rays transmitted through a subject are detected by the solid state detector to obtain image signals representing the X-ray image of the subject.

Various types of detectors are also proposed as the solid state radiation detectors for use in such systems. For example, from the aspect of charge generating process in which X-rays are converted to charges, scintillator type (indirect conversion type) solid state detectors, direct conversion type solid state detectors, and the like are proposed. In the scintillator type solid state detector, fluorescent light emitted from a phosphor scintillator when X-rays are irradiated thereon is detected by a photodetector to obtain signal charges, which are temporarily stored in the storage section, then the stored charges are outputted after converted to image signals (electrical signals). In the direct conversion type solid state detector, signal charges generated in the photoconductive layer when X-rays are irradiated thereon are collected by charge collection electrodes and temporarily stored in the storage section, thereafter the stored charges are outputted after converted to electrical signals. In the solid state detector of this type, the photoconductive layer and the charge collection electrodes constitute the main section.

Of the solid state radiation detectors described above, the direct conversion type is superior in the sharpness of images since it does not require a scintillator for converting radiation to light. The present invention is also relates to the direct conversion type solid state radiation detector having a photoconductive layer formed mainly of amorphous selenium.

In the mean time, from the aspect of charge readout process in which the stored charges are read out to outside, optical readout type detectors in which the stored charges are read out by irradiating readout light (readout electromagnetic wave) on the detector, TFT readout type detectors as described, for example, in U.S. Pat. No. 6,828,539 in which the charges are read out by scan driving TFTs (thin film transistors) connected to the storage section, and the like are proposed.

A modified direct conversion type solid state detector is also proposed by the inventor of the present invention in U.S. Pat. No, 6,268,614. The modified direct conversion type solid state detector proposed by the inventor is a direct conversion/optical readout type solid state detector. The detector includes the following layers arranged in the order listed below: a recording photoconductive layer that shows conductivity when exposed to recording light (X-rays, fluorescent light generated by the irradiation of X-rays, and the like); a charge transport layer that acts as substantially an insulator against charges having the same polarity as latent image charges and as substantially a conductor for transport charges having the opposite polarity to that of the latent image charges; and a readout photoconductive layer that shows conductivity when exposed to readout light. Here, signal charges (latent image charges) that represent image information are stored in the interface between the recording photoconductive layer and charge transport layer. An electrode layer (first conductive layer or second conductive layer) is provided on each side of the three-layer composite. In this type of solid state detector, the recording photoconductive layer, charge transport layer, and readout photoconductive layer constitute the main section of the detector.

In the solid state radiation detectors described above, amorphous selenium (a-Se), which is highly sensitive to radiation including X-rays and the like, is generally used for the photoconductive layer. The amorphous selenium, however, is likely to be influenced by the surrounding temperature and humidity. Therefore, a long term use of the detector without providing a protection film causes a problem that degradation in the sensitivity and image quality may progress. Further, Se has a low X-ray absorption rate so that it is necessary to make the Se layer relatively thick. As a result, a high bias voltage needs to be applied in order to make it function as the photoconductive layer. In the high electric field environment, a small defect developed in the Se may lead to a significant image defect. Therefore, it is customary that a protection film is applied to the solid state radiation detector using a glue or adhesive in order to protect the photoconductive layer.

In this case, however, the glue or adhesive applied to the protection film may infiltrate into the amorphous selenium, and spots may be developed in the detected image due to degradation in the properties of the amorphous selenium in the area where the adhesive has infiltrated. It may be considered that the adhesive is applied only the edge portion of the protection film to prevent the adhesive from contacting the amorphous selenium. In this case, however, a gap (airspace) is developed between the solid state radiation detector and the protection film, which causes a problem that a discharge breakdown is likely to occur in such area.

It has been found by the inventors of the present invention that a protection film provided in close contact with the Se and the electrode layer disposed on the upper side of the Se without any space is effective to avoid these problems, which has led to the present invention.

That is, it is an object of the present invention to provide a solid state radiation detector that includes a photoconductive layer formed mainly of amorphous selenium, in which the photoconductive layer is protected without causing the problems of spotty image, discharge breakdown, and the like.

### SUMMARY OF THE INVENTION

The solid state radiation detector of the present invention includes an electrostatic recording section having a photoconductive layer formed mainly of amorphous selenium, and is constructed to directly receive radiation transmitted through or emitted from a subject and representing image information by the photoconductive layer to record the image information, and to output image signals representing the recorded image information,

wherein the photoconductive layer is sealed by a polymer film formed by chemical vapor deposition.

The solid state radiation detector described above means a detector that detects radiation representing image information of a subject and outputs image signals representing the radiation image of the subject. More specifically, it converts irradiated radiation directly to charges; stores the charges in the storage section; and thereafter outputs the stored charges. Thereby image signals representing the radiation image of the subject are obtained.

The referent of “a photoconductive layer formed mainly of amorphous selenium” as used herein means a photoconductive layer in which amorphous selenium occupies the largest amount in weight percent among the components constituting the photoconductive layer.

Preferably, in the solid state radiation detector of the present invention, the polymer is selected from polyparaxylylene families. The referent of “polyparaxylylene families” as used herein means polyparaxylylene and its derivatives. Specific examples of the polyparaxylylene families include the following.

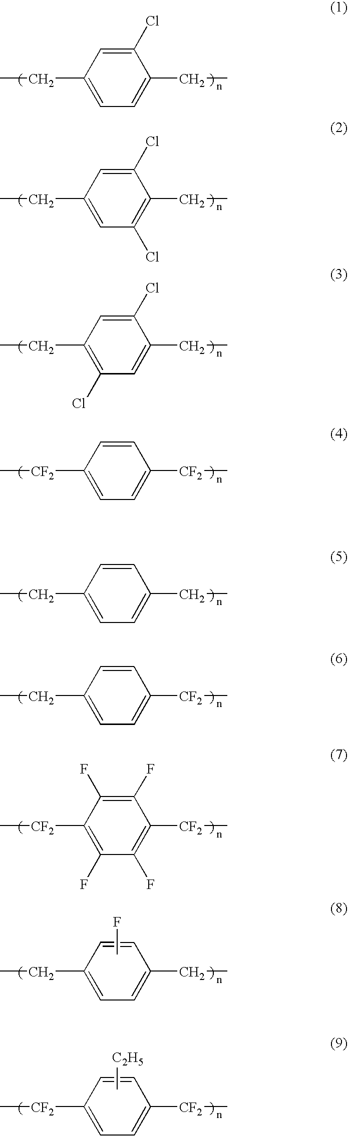

Of these, poly-monochloroparaxylyene, and poly-dichloroparaxylyene have low moisture permeability, and may be more preferably used as the polymer of the present invention.

Preferably, the thickness of the polyparaxylylene family is from 1 to 100 μm, and more preferably from 10 to 50 μm. Preferably, the upper surface of the polymer is further covered with a second film. Preferably, the thickness of the second film is from 5 to 50 μm.

The solid state radiation detector of the present invention includes an electrostatic recording section having a photoconductive layer formed mainly of amorphous selenium, and is constructed to directly receive radiation transmitted through or emitted from a subject and representing image information by the photoconductive layer to record the image information, and to output image signals representing the recorded image information, in which the photoconductive layer is sealed by a polymer film formed by chemical vapor deposition. This allows the photoconductive layer to be sealed without any gap between the polymer and the solid state radiation detector. Further, no adhesive is used so that no adhesive may infiltrate into the photoconductive layer formed mainly of amorphous selenium. Thus, the photoconductive layer formed mainly of amorphous selenium may be protected without the problems of spotty image, discharge breakdown, and the like.

Since the sealing is performed on the solid state radiation detector by a polymer film formed by chemical vapor deposition, even if a second film is further applied on the upper surface of the polymer using an adhesive, no adhesive may infiltrate into the photoconductive layer formed mainly of amorphous selenium. Therefore, the photoconductive layer may be protected more strongly by further sealing the upper surface of the polymer with the second film.

### BRIEF DESCRIPTION OF THE DRAWINGS

FIG. 1 is a cross-sectional view of the solid state radiation detector according to an embodiment of the present invention.

### DESCRIPTION OF THE PREFERRED EMBODIMENTS

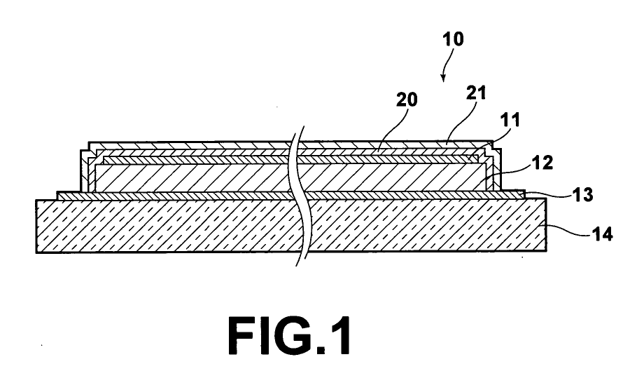

Hereinafter, an exemplary embodiment of the present invention will be described with reference to the accompanying drawing. FIG. 1 is a cross-sectional view of the solid state radiation detector according to an embodiment of the present invention.

The solid state radiation detector 10 includes the following layers arranged in the order listed below: a first conductive layer 11; a photoconductive layer 12 that generates charges when exposed to X-rays and shows conductivity; and a second conductive layer 13 that includes a readout circuit formed of a TFT and a pixel electrode.

The first conductive layer 11 may be made of any material as long as it is transparent to X-rays, and, for example, a gold film and the like may be used. In the present embodiment, it is made of a gold film with a thickness of 100 nm.

The photoconductive layer 12 is formed of amorphous selenium having high quantum efficiency with low dark current. In the present embodiment, the thickness of the photoconductive layer is 200 μm.

The second conductive layer 13 is formed of TFTs, each corresponding to each pixel, and the output line of each TFT is connected to a signal detection means (not shown) . Further, the control line of each TFT is connected to a TFT control means (not shown).

When X-rays are irradiated on the photoconductive layer 12, while an electric field is being formed between the first conductive layer 11 and the second conductive layer 13, the solid state radiation detector 10 generates charge pairs in the photoconductive layer 12, and stores latent image charges in the second conductive layer 13 according to the amount of generated charge pairs. When reading out the stored latent image charges, the TFTs in the second conductive layer 13 are sequentially driven to output an image signal, which is based on the latent image charge corresponding to each pixel, through the output line. These image signals are then detected by the signal detection means (not shown), and the electrostatic latent image represented by the latent image charges is read out.

In the solid state radiation detector 10 according to the present embodiment, the first conductive layer 11 and the photoconductive layer 12 are sealed by a polymer film 20 formed by chemical vapor deposition. Various types of polymers may be used as the polymer film 20 as long as they have low moisture permeability and do not change the properties of the amorphous selenium. For example, polyparaxylylene families are of such polymers.

The polyparaxylylene film is formed by chemical vapor deposition, more specifically, by chemical vapor deposition polymerization method. The method includes the following three steps: first step in which vaporization of solid dimeric di-para-xylylene, the raw material of the polyparaxylylene, occurs; second step in which diradical-paraxylylene is developed through thermal decomposition of the dimer; and third step in which adsorption of the diradical-paraxylylene to a substrate and polymerization occur simultaneously, thereby a high-molecular-weight polyparaxylylene film is formed.

These steps are performed, in general, at a vacuum of 0.1 to 100 Pa (10⁻³to 1 Torr), with a temperature of 100 to 200 degrees Celsius in the first step, 450 to 700 degrees Celsius in the second step, and room temperature in the third step. The polyparaxylylene film obtained by chemical vapor deposition polymerization method allows conformal coating on the substrate and the coating itself may be performed at room temperature, so that the substrate receives no thermal history by the coating.

Preferably, the thickness of the polymer 20 formed by chemical vapor deposition is from 1 to 100 μm, and more preferably, from 10 to 50 μm. In the present embodiment, poly para xylylene is used as the polymer 10, and deposited in the thickness of 15 μm through CVD method.

In this way, the solid state radiation detector 10 may be sealed without any gap, and no adhesive may infiltrate into the photoconductive layer 12 since no adhesive is used. Thus, the photoconductive layer 12 may be protected without causing the problems of spotted image, discharge breakdown, and the like.

Further, a second protective film 21 with adhesive is applied on the polymer 20. The second protective film 21 is a gas barrier film, and any material may be used for the second protective film 21 as long as it has such properties. More specifically, a laminated film formed of a high-polymer film layer and a thin metal layer, a laminated film formed of a high-polymer film layer and a thin oxide layer, and the like may be used. As for the thin metal film in the former, aluminum is preferably used, and as for the oxide in the latter, silicon oxide or aluminum oxide is preferably used. GX film available from Toppan Printing Co., Ltd may be a more specific example of the latter. Preferably, the thickness of the second protective film 21 is from 5 to 50 μm. In the present embodiment, GX film produced by Toppan Printing Co., Ltd is used as the second protective film 21.

Generally, the polyparaxylylene family used as the polymer 20 has low bonding strength with the other member bonded with an adhesive. But, the bonding strength may be increased by irradiating light thereon prior to bonding. The required time for the irradiation may be adjusted to an optimum time according to the wavelength of the ultraviolet source used and the wattage. Preferably, a low-pressure mercury lamp of 1 to 50 W is used for exposing the polyparaxylylene for 1 to 30 minutes.

In the present embodiment, the solid state radiation detector 10 is sealed by the polymer 20 formed by chemical vapor deposition, so that the application of the second protective film 21 on the upper surface of the polymer 20 using an adhesive causes no adhesive to infiltrate into the photoconductive layer 12 which is formed mainly of amorphous selenium. Therefore, the photoconductive layer 12 may be protected more strongly by further sealing the upper surface of the polymer 20 with the second protective film 21.

So far the exemplary embodiment of the present invention has been described, but the present invention is not limited to the TFT readout type solid state radiation detector. The present invention may be applied to any solid state radiation detector that includes a photoconductive layer formed mainly of amorphous selenium.

What is claimed is:

1. A solid state radiation detector comprising an electrostatic recording section having a photoconductive layer formed mainly of amorphous selenium, and is constructed to directly receive radiation transmitted through or emitted from a subject and representing image information by the photoconductive layer to record the image information, and to output image signals representing the recorded image information,
wherein the photoconductive layer is sealed by a polymer film formed by chemical vapor deposition.

2. The solid state radiation detector according to claim 1, wherein the polymer is a polyparaxylylene family.

3. The solid state radiation detector according to claim 2, wherein the film thickness of the polyparaxylylene family is from 1 to 100 μm.

4. The solid state radiation detector according to claim 2, wherein the film thickness of the polyparaxylylene family is from 10 to 50 μm.

5. The solid state radiation detector according to claim 1, wherein the upper surface of the polymer is sealed with a second film.

6. The solid state radiation detector according to claim 2, wherein the upper surface of the polymer is sealed with a second film.

7. The solid state radiation detector according to claim 3, wherein the upper surface of the polymer is sealed with a second film.

8. The solid state radiation detector according to claim 4, wherein the upper surface of the polymer is sealed with a second film.

9. The solid state radiation detector according to claim 5, wherein the thickness of the second film is from 5 to 50 μm.

10. The solid state radiation detector according to claim 6, wherein the thickness of the second film is from 5 to 50 μm.

11. The solid state radiation detector according to claim 7, wherein the thickness of the second film is from 5 to 50 μm.

12. The solid state radiation detector according to claim 8, wherein the thickness of the second film is from 5 to 50 μm.
